(19) United States
(12) Patent Application Publication
(10) Pub. No.: US 2011/0212398 A1
(43) Pub. Date: Sep. 1, 2011

(54) TONER FOR DEVELOPING ELECTROSTATIC LATENT IMAGES AND PRODUCTION METHOD OF THE SAME

(75) Inventors: Kenji HAYASHI, Tokyo (JP); Mikio KOUYAMA, Tokyo (JP); Hiroaki OBATA, Tokyo (JP); Koji SHIBATA, Tokyo (JP)

(73) Assignee: KONICA MINOLTA BUSINESS TECHNOLOGIES, INC., Tokyo (JP)

(21) Appl. No.: 13/030,631

(22) Filed: Feb. 18, 2011

(30) Foreign Application Priority Data
Feb. 26, 2010 (JP) 2010-041258

(51) Int. Cl. G03G 9/087

(52) U.S. Cl. 430/109.3; 430/137.14; 430/137.11

(57) ABSTRACT

A toner for developing electrostatic latent images, including a binder resin, and a colorant, wherein the binder resin includes an amorphous resin obtained from a radical polymerizable monomer unit containing a styrene type monomer and a (meth)acrylic ester type monomer and a crystalline resin, and a ratio (Q2/Q1) is 0.85 or more, where Q1 represents an amount of absorbed heat based on an endothermic peak derived from the crystalline resin in a first temperature rising process from 0° C. to 200° C. in measurement with a differential scanning calorimeter, and Q2 represents an amount of absorbed heat based on an endothermic peak derived from the crystalline resin in a second temperature rising process from 0° C. to 200° C.

This application is based on Japanese Patent Application No. 2010-041258 filed on Feb. 26, 2010, in Japanese Patent Office, the entire content of which is hereby incorporated by reference.

### BACKGROUND OF THE INVENTION

The present invention relates to toner for developing electrostatic latent images and production method of the toner.

Conventionally, in image forming methods of forming visible images with electrophotography, as a method of fixing toner images formed with toner for developing electrostatic latent images (hereafter, merely referred to as “toner”) on image recording sheets, such as paper, for example, a heat roller fixing system has been widely employed. In the heat roller fixing system, a toner image formed on an image recording sheet is fixed such that the image recording sheet is conveyed to pass between a heating roller and a pressing roller. In such a heat roller fixing system, in order to ensure fixing ability, i.e., adherence properties of toner for an image recording sheet, the heating roller is required to provide a certain large amount of heat.

However, in recent years, in view of requests of the warming preventive measures of global environment, energy saving is requested also in the electrophotography type image forming apparatuses adopting the heat roller fixing system. Accordingly, in order to respond to such requests, techniques to reduce an amount of heat necessary for fixing toner images have been studied. For examples, a technique is proposed to enhance a low temperature fixing ability of toner by combining a crystalline resin and an amorphous resin as resin to constitute the toner (for example, refer to Japanese Unexamined Patent Publication No. 2005-300867, Official Report).

However, in toner which contains a crystalline resin together with an amorphous resin as resin, there are the following problems. That is, in the production process of toner and in a process of fixing a toner image in an image forming process of forming a visual image, when the toner is subjected to heat histories, the crystalline resin dissolves into the amorphous resin. Accordingly, since the crystalline resin dissolves into the amorphous resin, the glass transition point of the toner falls. Successively, due to the lowering of the glass transition point, the heat resistance properties (thermal strength) of the toner become small, which results in various adverse effects. Specifically, the lowering of the glass transition point causes problems that for example, during storage of toner, or in a toner box in a developing device in an image forming process, toner aggregates to result in blocking. Further, a document offset phenomenon takes place in an obtained visible image.

### SUMMARY OF THE INVENTION

The present invention has been achieved under the abovementioned circumstances, and an object of the present invention is to provide toner for developing electrostatic latent images and a production method of the toner, wherein the toner has low temperature fixing ability, in addition, excellent heat resistance storage stability (blocking resistance) and document offset resistance.

The above object can be attained by the following toner for developing electrostatic latent images which reflects one aspect of the present invention.

A toner for developing electrostatic latent images, includes:
a binder resin, and
a colorant,
   wherein the binder resin includes an amorphous resin obtained from a radical polymerizable monomer unit containing a styrene type monomer and a (meth)acrylic ester type monomer and a crystalline resin, and a ratio (Q2/Q1) is 0.85 or more, where Q1 represents an amount of absorbed heat based on an endothermic peak derived from the crystalline resin in a first temperature rising process from 0° C. to 200° C. in measurement with a differential scanning calorimeter, and Q2 represents an amount of absorbed heat based on an endothermic peak derived from the crystalline resin in a second temperature rising process from 0° C. to 200° C.

### BRIEF DESCRIPTION OF THE DRAWINGS

FIG. 1 is a DSC curve obtained by measuring a sample (toner) containing at least a crystalline resin and a release agent with a differential scanning calorimeter (DSC), and the DSC curve shows an example in the case where the endothermic peak derived from the crystalline resin overlaps with the endothermic peak derived from the release agent.

### DETAILED DESCRIPTION OF THE PREFERRED EMBODIMENT

Hereafter, the preferred embodiment of the present invention will be explained in detail. However, the present invention is not limited to this embodiment.

The toner of the present invention for developing electrostatic latent images is toner for developing electrostatic latent images which is composed of toner particles containing at least a binder resin and a colorant, and the binder resin is composed of an amorphous resin and a crystalline resin.

In the toner of the present invention, a ratio (Q2/Q1) is 0.85 or more, where Q1 represents an amount of absorbed heat based on an endothermic peak (heat absorption peak) derived from the crystalline resin in a first temperature rising process from 0° C. to 200° C. in a measurement with a differential scanning calorimeter, and Q2 represents an amount of absorbed heat based on an endothermic peak derived from the crystalline resin in a second temperature rising process from 0° C. to 200° C.

The ratio (Q2/Q1) is a value which shows a non-compatible rate showing the degree of suppression to suppress a crystalline resin from being compatible with an amorphous resin in toner, and the ratio shows that as its value becomes closer to 1, the non-compatible rate becomes higher. In other words, as the ratio (Q2/Q1) becomes closer to 1, a crystalline resin exists independently from an amorphous resin without dissolving into the amorphous resin. Due to the fact that the ratio (Q2/Q1) resides in the above range, even if toner has been subjected to heat histories, the crystalline resin is suppressed from dissolving into the amorphous resin. As a result, the crystalline resin does not dissolve into the amorphous resin so that the glass transition point of toner does not fall greatly. Accordingly, it becomes possible to obtain sufficient heat resistance storage stability (blocking resistance) and document offset resistance.

In the case where the ratio (Q2/Q1) is less that 0.85, when toner is subjected to heat histories, the glass transition point of toner falls. Then, due to this, since the heat resistance of the toner becomes small, it becomes difficult to obtain sufficient heat resistance storage stability (blocking resistance) and document offset resistance. Concretely, there are problems that during storage of toner, or in a toner box in a developing device in an image forming process, toner aggregates to result in blocking. Further, a document offset phenomenon takes place in an obtained visible image.

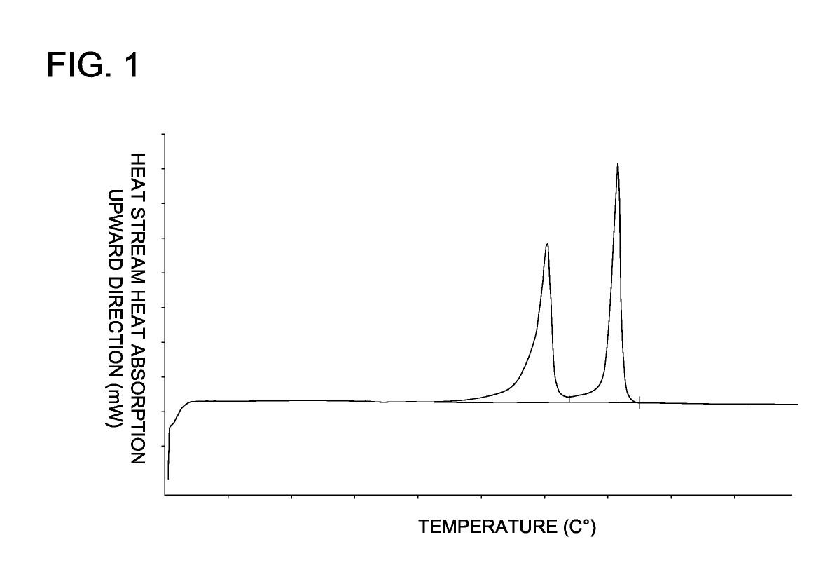

An endothermic peak is used to obtain an amount of absorbed heat Q1 and an amount of absorbed heat Q2 for obtaining a ratio (Q2/Q1) by a differential scanning calorimeter (DSC). Such an endothermic peak is measured specifically in such a way that as the differential scanning calorimeter, for example, “Diamond DSC” (manufactured by Perkin-Elmer) may be used, and the measurement is conducted on the conditions (temperature rising and cooling conditions) including sequentially a first temperature rising process of rising temperature from 0° C. to 200° C. at a rising rate of 10° C./minute, a cooling process of cooling from 200° C. to 0° C. at a cooling rate of 10° C./minute, and a second temperature rising process of rising temperature from 0° C. to 200° C. at a rising rate of 10° C./minute. On the basis of a DSC curve obtained by the above measurement, an amount of absorbed heat Q1 [J/g] is obtained by the calculation of an amount of heat per unit weight from the endothermic peak derived from a crystalline resin in the first temperature rising process, and an amount of absorbed heat Q2 [J/g] is obtained by the calculation of an amount of heat per unit weight from the endothermic peak derived from the crystalline resin in the second temperature rising process. As the measurement procedure, the weight of sample toner from 1.0 mg to 3.0 mg is determined accurately to two digits after decimal point, the sample toner is capsulated in an aluminium pan, and the aluminium pan is set in a sample holder of “Diamond DSC”. As reference, an empty aluminium pan is used. In the DSC curve obtained by the measurement using such a differential scanning calorimeter (DSC), an amount of absorbed heat (ΔH [J/g]) based on an endothermic peak derived from a crystalline resin is an endothermic peak derived from only a crystalline resin except an endothermic peak derived from a release agent. Accordingly, the amount of absorbed heat (ΔH [J/g]) is represented by an amount of energy ΔH [J/g] calculated from an area of a heat absorption wave defined with an endothermic peak (heat absorption peak) and a base line. At the time of calculating an amount of absorbed heat based on an endothermic peak derived from a crystalline resin, there is no problem in the case where the endothermic peak derived from a crystalline resin exists independently and is clear. However, as shown in FIG. 1, in the case where the endothermic peak derived from a crystalline resin overlaps with an endothermic peak derived from a release agent, a vertical straight line is drawn to a base line from the minimum value at a valley portion at which two endothermic peaks (heat absorption waves) overlaps with each other so that the heat absorption wave or an amount of absorbed heat derived from the crystalline resin is separated by the vertical straight line.

### [Binder Resin]

A binder resin constituting the toner of the present invention is composed of an amorphous resin obtained from a radical polymerizable monomer unit containing a styrene type monomer and a (meth)acrylate type monomer and a crystalline resin.

### [Crystalline Resin]

In a DSC curve measured with a differential scanning calorimeter (DSC), the crystalline resin relating to the toner of the present invention has a clear endothermic peak.

The crystalline resin relating to the toner of the present invention has a melting point (Tm) of preferably 40 to 95° C., and more preferably 50 to 90° C.

If the melting point of the crystalline resin is too low, the heat resistance properties (thermal strength) of toner fall. Accordingly, there is fear that it is difficult to obtain sufficient heat-resistance storage stability and document offset resistance. On the other hand, if the melting point of the crystalline resin is too high, there is another fear that it is difficult to obtain sufficient low temperature fixing ability.

The melting point (Tm) of the crystalline resin is measured by use of a differential scanning calorimeter (DSC) as with the measurement of the abovementioned ratio (Q2/Q1), and the melting point is shown with the endothermic peak top temperature derived from the crystalline resin in the second temperature rising process.

The crystalline resin relating to the present invention has a number average molecular weight of preferably 1,500 to 15,000, and more preferably 2,000 to 10,000.

If the number average molecular weight is too large, a cold offset (low temperature offset) phenomenon tends to be caused easily. Accordingly, there is fear that it is difficult to obtain sufficient fixing ability. On the other hand, if the number average molecular weight is too small, a hot offset (high temperature offset) phenomenon tends to be caused easily. Accordingly, there is another fear that it is difficult to obtain sufficient fixing ability.

The number average molecular weight of the crystalline resin is measured by gel permeation chromatography (GPC). Concretely, for example, it is measured by use of “HLC-8120 GPC” (manufactured by Tosoh Corporation) as a measuring apparatus and a standard polystyrene calibration curve as a calibration curve.

The content of the crystalline resin is preferably 10 to 60 weight % to the whole binder resin from the viewpoint of reservation of low temperature fixing ability and document offset resistance.

Specific examples of the crystalline resin relating to the present invention include a crystalline polyester resin, a crystalline vinyl type resin and the like. From the viewpoint of adhesive properties for image recording sheets, such as paper in the process of fixing, and the adjustment ability to adjust electrostatic properties and a melting point into respective desired ranges, a crystalline polyester resin is desirable. Further, an aliphatic type crystalline polyester resin having a proper melting point is more desirable.

As the crystalline polyester resin, among well-known polyester resins obtained by the polycondensation reaction of a carboxylic acid compound (multivalent carboxylic acid compound) of divalent or more and an alcohol compound (polyol compound) of divalent or more, a polyester resin having crystallinity may be employed.

The carboxylic acid compound (multivalent carboxylic acid compound) of divalent or more is a compound which includes two or more carboxyl groups in one molecule. Specific examples of the multivalent carboxylic acid compound include saturated fat group dicarboxylic acids, such as oxalic acid, malonic acid, succinic acid, adipic acid, sebacic acid, azelaic acid, and n-dodecylsuccinic acid; alicyclic dicarboxylic acids, such as cyclohexanedicarboxylic acid; aromatic dicarboxylic acids, such as phthalic acid, isophthalic acid, and terephthalic acid; trimellitic acids; multivalent carboxylic acids being more than trivalent, such as pyromellitic acid; an anhydride of these carboxylic acid compounds and alkyl ester with a carbon number of 1 to 3. These compounds may be used solely or in a combination of two or more kinds.

The polyol compound (multivalent alcohol compound) being more than divalent is a compound which includes two or more hydroxyl groups in one molecule. Specific examples of the polyol compound include aliphatic series diol, such as 1,2-propanediol, 1,3-propanediol, 1,4-butanediol, 1,5-pentanediol, 1,6-hexanediol, 1,7-heptanediol, 1,8-octanediol, neopentylglycol, and 1,4-butenediol; polyol being more than trivalent, such as glycerol, pentaerythritol, trimethylolpropane, and sorbitol; and the like. These compounds may be used solely or in a combination of two or more kinds.

Examples of the crystalline vinyl type resin include vinyl type resins obtained by use of a (meta)acrylic acid ester of long-chain alkyl or alkenyl, such as (meta)acrylic acid amyl, (meta)acrylic acid hexyl, (meta)acrylic acid heptyl, (meta)acrylic acid octyl, (meta)acrylic acid nonyl, (meta)acrylic acid decyl, (meta)acrylic acid undecyl, (meta)acrylic acid tridecyl, (meta)acrylic acid myristyl, (meta)acrylic acid cetyl, (meta)acrylic acid stearyl, (meta)acrylic acid oleyl, and (meta)acrylic acid behenyl. Herein, in the present specification, (meta)acrylic means to include both “acryl” and “methacryl”.

### [Amorphous Resin]

The amorphous resin relating to the toner of the present invention is a polymer obtained from a radical polymerizable monomer unit containing a styrene type monomer and a (meta)acrylic acid ester type monomer, that is, a copolymer having a structural unit derived from a styrene type monomer and a structural unit derived from a (meta)acrylic acid ester type monomer.

Examples of the styrene type monomer for obtaining the amorphous resin of the present invention include styrene, o-methylstyrene, m-methylstyrene, p-methylstyrene, p-methoxy styrene, p-phenylstyrene, p-chlorostyrene, p-ethylstyrene, p-n-butyl styrene, p-tert-butyl styrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, their derivative, and the like. These monomers may be used solely or in a combination of two or more kinds.

Examples of the (meta)acrylic acid ester type monomer for obtaining the amorphous resin of the present invention include methyl acrylate, ethyl acrylate, butyl acrylate, 2-ethyl hexyl acrylate, cyclohexyl acrylate, phenyl acrylate, methyl methacrylate, ethyl methacrylate, butyl methacrylate, hexyl methacrylate, 2-ethyl hexyl methacrylate, β-hydroxyethyl acrylate, propyl γ-aminoacrylate, stearyl methacrylate, dimethylaminoethyl methacrylate, diethylaminoethyl methacrylate, and the like. These compounds may be used solely or in a combination of two or more kinds.

Further, the radical polymerizable monomer unit for obtaining the amorphous resin of the present invention may contain a radical polymerizable monomer other than the styrene type monomer and (meth)acrylate type monomer. That is, the copolymer constituting the amorphous resin of the present invention is allowed to merely contain a structural unit derived from the styrene type monomer and a structural unit derived from the (meta)acrylic acid ester type monomer of the origin, and further the copolymer may contain a structural unit derived from other radical polymerizable monomers.

Examples of other radical polymerizable monomers include, without being specifically limited, a vinyl ester type monomer, a vinyl ether type monomer, a mono-olefin type monomer, a diolefin type monomer, a halogenated olefin type monomer, and the like.

Examples of the vinyl ester type monomer include vinyl acetate, vinyl propionate, vinyl benzoate, and the like.

Examples of the vinyl ether type monomer include vinylmethyl ether, vinylethyl ether, vinyl isobutyl ether, vinylphenyl ether, and the like.

Examples of the mono-olefin type monomer include ethylene, propylene, isobutylene, 1-butene, 1-pentene, 4-methyl-1-pentene, and the like.

Examples of the diolefin type monomer include butadiene, isoprene, chloroprene, and the like.

Examples of the halogenated olefin type monomer include vinyl chloride, vinylidene chloride, vinyl bromide, and the like.

Furthermore, for the radical polymerizable monomer unit for obtaining the amorphous resin of the present invention, a radical polymerizable cross-linking agent may be employed in order to improve the characteristics of toner, if needed, and it is desirable to use at least one kind of monomer selected from a radical polymerizable monomer having an acidic group and a radical polymerizable monomer having a basic group.

Examples of the radical polymerizable cross-linking agent include compounds having two or more unsaturated bonds, such as divinylbenzene, divinylnaphthalene, divinyl ether, diethylene glycol methacrylate, ethylene glycol dimethacrylate, polyethylene glycol dimethacrylate, diallyl phthalate, and the like.

A used amount of the radical polymerizable cross-linking agent is preferably 0.1 to 10 weight % to the whole radical polymerizable monomer unit (total amount of the used monomer) for obtaining the amorphous resin.

Examples of the radical polymerizable monomer having an acidic group include carboxylic acid group containing monomers, such as acrylic acid, methacrylic acid, fumaric acid, maleic acid, itaconic acid, cinnamic acid, maleic acid monobutyl ester, and maleic acid monooctyl ester; and sulfonic acid group containing monomers, such as styrene sulfonic acid, allylsulfosuccinic acid, octyl, allylsulfosuccinate and the like.

Further, the radical polymerizable monomer having an acidic group has totally or partially a structure of alkaline earth metal salt, such as sodium and potassium; alkaline metal salt, such as calcium.

A used amount of the radical polymerizable monomer having an acidic group is preferably 0.1 to 20 weight % to the whole radical polymerizable monomer unit (total amount of the used monomer) for obtaining the amorphous resin and more referably 0.1 to 15 weight %.

Examples of the radical polymerizable monomer having a basic group include amine type compounds, such as primary amine, secondary amine, tirtiary amine, and quartemary ammonium salt, and the like. Specific examples of amine type compounds include dimethylamino ethyl acrylate, dimethylamino ethyl methacrylate, diethylamino ethyl acrylate, diethylaminoethyl methacrylates, and their quartemary ammonium salt, 3-dimethylamino phenyl acrylate, 2-hydroxy-3-methacryloxypropyl trimethyl ammonium salt, acrylamide, N-butylacrylamide, N,N-dibutylacrylamide, piperidyl acrylamide, methacrylamide, N-butylmethacrylamide, N-octadecylacrylamide; vinylpyridine, vinyl-pyrrolidone; vinyl N-methylpyridiniumchloride, vinyl N-ethylpyridiniumchloride, N,N-diallylmethyl ammonium chloride, N,N-diallylethyl ammonium chloride, and the like.

A used amount of the radical polymerizable monomer having a basic group is preferably 0.1 to 20 weight % to the whole radical polymerizable monomer unit (total amount of the used monomer) for obtaining the amorphous resin and more referably 0.1 to 15 weight %.

The amorphous resin relating to the present invention has a glass transition point (Tg) of preferably 25 to 50° C., and preferably 25 45° C. If the glass transition point of the amorphous resin is too low, the heat resistance properties (thermal strength) of toner fall. Accordingly, there is fear that it is difficult to obtain sufficient heat-resistance storage stability and document offset resistance. On the other hand, if the glass transition point of the amorphous resin is too high, there is fear that it is difficult to obtain sufficient low temperature fixing ability.

The glass transition point (Tg) of the amorphous resin is measured by use of a differential scanning calorimeter (DSC) as with the measurement of the abovementioned ratio (Q2/Q1), and the glass transition point is shown with the endothermic curve derived from the amorphous resin in the second temperature rising process. That is, the glass transition point is shown with an intersection point between a extension line of the baseline before the rising-up of the first endothermic peak in the endothermic curve and a tangent line drawn so as to show a maximum inclination between the rising-up portion of the first endothermic peak and the peak apex.

In the toner of the present invention, the binder resin is composed of an amorphous resin and a crystalline resin, and since the crystalline resin does not have a glass transition point, the glass transition point of the amorphous resin constituting the binder resin becomes the glass transition point of the binder resin. In the case where two or more kinds of amorphous resins are used as resin constituting toner, the glass transition point of those mixtures (mixed resin) becomes the glass transition point of toner.

### [Colorant]

As colorant constituting the toner relating to the present invention, well-known inorganic or organic colorants may be employed. Hereafter, specific colorants will be shown.

Examples of black colorant include carbon black, such as furnace black, channel black, acetylene black, thermal black, and lamp black; and magnetic powders such as magnetite, ferrite, and the like.

Examples of colorants for magenta or red include C.I. pigment red 2, C.I. pigment red 3, C.I. pigment red 5, C.I. pigment red 6, C.I. pigment red 7, C.I. pigment red 15, C.I. pigment red 16, and C.I. pigment red 48:1, C.I. pigment red 53:1, C.I. pigment red 57:1, CJ. pigment red 122, C.I. pigment red 123, C.I. pigment red 139, C.I. pigment red 144, C.I. pigment red 149, C.I. pigment red 166, the C.I. pigment red 177, C.I. pigment red 178, C.I. pigment red 222, and the like.

Examples of colorants for orange or yellow include C.I. pigment orange 31, C.I. pigment orange 43, C.I. pigment yellow 12, C.I. pigment yellow 13, C.I. pigment yellow 14, C.I. pigment yellow 15, C.I. pigment yellow 74, C.I. pigment yellow 93, C.I. pigment yellow 94, C.I. pigment yellow 138, and the like.

Examples of colorants for green or cyan include C.I. pigment blue 15, C.I. pigment blue 15:2, C.I. pigment blue 15:3, C.I. pigment blue 15:4, C.I. pigment blue 16, C.I. pigment blue 60, C.I. pigment blue 62, C.I. pigment blue 66, C.I. pigment green 7, and the like.

These colorants may be used solely or in a combination of two or more kinds.

The content ratio of colorants is made in the range of 1 30 mass % to the whole toner, and preferably in the range of 2 to 20 mass %.

The colorants may be subjected to a surface modification treatment. As such a surface modifier, conventionally well known agents may be employed. Preferable examples of the surface modifier include a silane coupling agent, a titanium coupling agent, an aluminium coupling agent, and the like.

The toner of the present invention may contain inner additives, such as magnetic powder, an electric charge control agent, and a release agent if required.

### [Magnetic Powder]

As the magnetic powder, for example, magnetite, γ-hematite, or various ferrites may be employed. The content ratio of the magnetic powder is preferably 10 to 500 parts by mass to 100 parts by mass of the binder resin, and more preferably 20 to 200 parts by mass.

[Charge controlling Agent]

As a charge controlling agent, if substances can provide positive or negative charge by frictional electrification, the substances may be employed without being limited to. Actually, well-known various positive charge controlling agents and negative charge controlling agents may be employed. Specific examples of the positive charge controlling agents include Nigrosine series dye compounds, such as “Nigrosine Base EX” (manufactured by Orient Chemical Industries Co., Ltd.); quarternary ammonium salts, such as “Quarternary ammonium salt P-51” (manufactured by Orient Chemical Industries Co., Ltd.) and “Copy charge PX VP435” (manufactured by Hoechst Japan Limited); and imidazole compounds, such as alkoxy-modified amine, alkyl amide, molybdic acid chelate pigments, and “PLZ1001” (manufactured by Shikoku Chemicals Corporation). Specific examples of the negative charge controlling agents include metal complexes, such as “BONTRON S-22” (manufactured by Orient Chemical Industries Co., Ltd.), “BON IRON S-34” (manufactured by Orient Chemical Industries Co., Ltd.), “BONTRON E-81” (manufactured by Orient Chemical Industries Co., Ltd.), “BONTRON E-84” (manufactured by Orient Chemical Industries Co., Ltd.), and “Spiron black TRH” (manufactured by Hodogaya Chemical Co., Ltd.); quartemary ammonium salts, such as thioindigo system pigments and “Copy charge NX V434” (manufactured by Hoechst Japan); carixarene compounds, such as “BONTRON E-89” (manufactured by Orient Chemical Industries Co., Ltd.); boron compounds, such as “LR147” (manufactured by Japan Carlit Co., Ltd.); and fluorine compounds, such as magnesium fluoride, carbon fluoride, and the like. Examples of metal complexes employed as the negative charge controlling agents include, in addition to the above compounds, compounds having various structures, such as an oxycarboxylic acid metal complex, a dicarboxylic acid metal complex, an amino acid metal complex, a diketone metal complex, an diamine metal complex, an azo-containing benzene-benzene derivative skeleton metal body, an azo-containing benzene-naphthalene derivative skeleton metal complex, and the like.

The content ratio of the charge controlling agent is preferably 0.01 to 30 parts by mass to 100 parts by mass of the binder resin, and more preferably 0.1 to 10 parts by mass.

### [Release Agent]

As release agents, well-known various waxes may be employed. Preferable examples of waxes include polyolefine system waxes, such as low molecular weight polypropylene, polyethylene, oxidation type polypropylene, and polyethylene; and ester system waxes, such as behenic acid behenate, and the like. Specific examples of waxes include polyolefine waxes such as polyethylene wax and a polypropylene wax; branched-chain hydrocarbon waxes such as microcrystalline wax; long-chain hydrocarbon system waxes such as paraffin wax and sasol wax; dialkyl ketone system waxes such as distearyl ketone; ester type waxes, such as carnauba wax, montan wax, behenic acid behenate, trimethylolpropane tribehenate, pentaerythritol tetrabehenate, pentaerythritol diacetate dibehenate, glycerol tribehenate, 1,18-octadecanediol distearate, trimellitic acid tristearyl, distearyl maleate; and amide system waxes, such as ethylenediamine behenyl amide, trimellitic acid tristearyl amide, and the like. Among them, from the viewpoint of the release ability at the time of low-temperature fixing, waxes having a low melting point (specifically, a melting point of 40 to 90° C.) is desirable.

The content ratio of the release agent is preferably 1 to 30 mass % to the whole toner.

### [External Additive Agent]

In order to improve flowability, electrostatic property, cleaning nature, and the like, the toner of the present invention may be added with external additive agents, such as a fluidizer and a cleaning auxiliary agent.

Examples of external additive agents include inorganic fine particles, such as inorganic oxide fine particles, such as, silica fine particles, alumina fine particle, and titanium oxide fine particles; inorganic stearic acid compound fine particles, such as aluminum stearate fine particles and zinc stearate fine particles; and inorganic titanic acid compound fine particles, such as such as strontium titanate, zinc titanate, and the like. From a viewpoint of a heat-resistant storage stability and environmental stability, it is desirable that above inorganic fine particles are subjected to a surface treatment with a silane coupling agent, a titanium coupling agent, a higher fatty acid, silicone oil, and the like.

The added amount of such external additive agents is 0.05 to 5 parts by mass to 100 parts by mass of toner, and preferably 0.1 to 3 parts by mass. Further, the external additive agents may be used in a combination of various kinds of them.

### [Glass Transition Point of Toner]

In the toner of the present invention, as mentioned above, the glass transition point of an amorphous resin constituting the toner is the glass transition point of the toner, and is measured by use of a differential scanning calorimeter (DSC).

### [Particle Size of Toner]

The particle size of toner particles constituting the toner of the present invention is preferably 3 to 10 μm, for example, as a volume-based median size, and more preferably 5 to 8 μm. Due to that fact that the volume-based median size of toner particles resides in the above range, transfer efficiency becomes high, which results in that a half tone image quality is improved and the image quality of thin lines and dots also is improved.

The volume-based median size of toner particles is measured and calculated by use of a measurment apparatus in which a data processing computer system (manufactured by Beckman Coulter) is connected to “COULTER Multisizer 3” (manufactured by Beckman Coulter Inc.). Concretely, 0.02 g of toners are added into 20 mL of a surfactant solution (for the purpose of dispersing toners, for example, a surfactant solution in which a neutral detergent containing surfactant components is diluted by ten times with purified water) and is made to become familiar with the solution, and thereafter the resultant solution is subjected to an ultrasonic dispersion treatment for one minute so as to prepare a dispersion liquid of toner particles. Then, this dispersion liquid of toner particles is put by a pipet into a beaker containing “ISOONII” (manufactured by Beckman Coulter Inc.) placed in a sample stand until a display concentration in the measurement device becomes 5% to 10%. Here, this concentration range makes it possible to obtain reproducible measurement values. In this measurement device, the count number of measured particles is set to 25,000 pieces, an aperture size is set to 100 μm, and a measurement range of 2 to 60 μm is divided into 256 divisions. In the measurement, a frequency value is calculated for each division, and the, a 50% particle size from the large side of a volume cumulative fraction is made as a volume-based median size.

### [Degree of Circularity of Toner]

From a viewpoint of improvement in transfer efficiency, the average degree of circularity of toner particles constituting the toner of the present invention is preferably 0.930 to 1.000, and more preferably 0.950 to 0.995.

The degree of circularity of toner is a value measured by “FPIA-2100” (manufactured by Sysmex Corporation). Concretely, a sample (toner particles) is added into a solution in which a surfactant is dissolved in a commercially available exclusive sheath liquid and is made to become familiar with the solution, and thereafter the resultant solution is subjected to an ultrasonic dispersion treatment for one minute so as to prepare a dispersion liquid of toner particles. This dispersion liquid is subjected to measurement by use of “FPIA-2100”, on a measurement condition of a HPF (high magnification image photography) mode with a proper concentration of the HPF detection number of 3,000 to 10,000 pieces. Here, this concentration range makes it possible to obtain reproducible measurement values. Then, the degree of circularity represented by the following formula (T) is calculated based on the measurement values obtained by the above measurement.

Degree of circularity=(peripheral length of a circle having the same projection area as that of a particle image)/(peripheral length of a particle projection image) Formula (T)

Further, an average degree of circularity is an average value of respective degrees of circularity of toner particles. That is, an average degree of circularity is calculated in such a way that the respective degrees of circularity of toner particles are summed and the resultant total degree is divided by the number of all toners particles.

### [Developer]

The toner of the present invention may be used as a magnetic or nonmagnetic one component developer, and also may be used as a two component developer by being mixed with carrier. In the case where the toner of the present invention is used as a two component developer, examples of carrier include magnetic particles composed of conventionally well-known materials, such as compounds of ferromagnetic metals, such as iron; alloys of ferromagnetic metals and aluminium or lead; and ferromagnetic metals, ferrite, and magnetite, and specifically, ferrite particles are desirable. Further, examples of such carrier include a coated carrier in which the surfaces of magnetic particles are covered with covering material, such as resin, and a binder type carrier on which magnetic substance fine powders are dispersed in a binder resin. Examples of covering resins constituting the coated carrier include, without specific restriction, olefin system resins, styrene system resins, styrene acrylic system resins, silicone system resins, ester resins, fluorine resins, and the like. Further, examples of resins constituting the resin dispersion type carrier include, without specific restriction, styrene acrylic type resins, polyester resin, fluorine resin, phenol resin, and the like.

The volume-based median size of carrier is preferably 20 to 100 μm, and preferably 20 to 60 μm. The volume-based median size of carrier can be measured typically by a laser diffraction type particle size distribution measuring apparatus “HELOS” (manufactured by Sympatec Corporation) equipped with a wet type dispersion device.

### [Structure of Toner]

As is clear from the matter that the ratio (Q2/Q1) is required to be 0.85 or more, the toner of the present invention has a structure (toner inner structure) that a binder resin is composed of an amorphous resin obtained from a radical polymerizable monomer unit containing a styrene type monomer and a (meth)acrylate type monomer and a crystalline resin, and the amorphous resin and the crystalline resin are in a non-compatible state, that is, the crystalline resin does not dissolve into the amorphous resin and exists on a dispersion state in the amorphous resin. As a specific preferable example, the crystalline resin is dispersed as crystalline resin fine particles with a size of submicron order in the amorphous resin obtained from a radical polymerizable monomer unit containing a styrene type monomer and a (meth)acrylate type monomer.

Further, in the toner of the present invention, toner particles may have a core/shell structure composed of a core particle (a colored particle which includes a binder resin composed of a crystalline resin and an amorphous resin and a colorant), and a shell composed of an amorphous resin (hereafter, also referred to as “amorphous resin for shell (shell-use amorphous resin)”) to cover the peripheral surface of the core particle. Due to the reason that toner particles have the core/shell structure, high manufacture stability and storage stability can be expected. Herein, “core/shell structure” may include not only a configuration that a shell covers completely a core particle, but also a configuration that a shell covers partially a core particle. Further, the shell may have a multi layer structure of two or more layers composed of multi resins (amorphous resins) different in composition.

In the toner having the above structure, the content ratio of the shell-use amorphous resin which constitutes a shell is preferably 5 mass % or more and 30 mass % or less to the whole toner.

The employable shell-use amorphous resin is not compatible to the binder resin (amorphous resin and crystalline resin) constituting core particles and has a high glass transfer point. Further, the shell-use amorphous resin has preferably a glass transition point of 45° C. or more and 60° C. or less, and has preferably a weight average molecular weight of 8000 or more and 50,000 or less.

According to the toner of the present invention described above, a binder resin is composed of an amorphous resin and a crystalline resin, and even if toner has been subjected to heat histories, the crystalline resin is suppressed from dissolving into the amorphous resin, so that the toner has desired heat resistance capabilities (heat-resistant strength). Accordingly, since the crystalline resin does not dissolve into the amorphous resin, the glass transition point of toner does not fall greatly. Therefore, it becomes possible to obtain low temperature fixing ability, and also to obtain excellent heat resistance storage stability (blocking resistance) and document offset resistance. Herein, in the toner of the present invention, the structure of a binder resin is controlled by the existence state of an amorphous resin and a crystalline resin. Namely, the crystalline resin is made to crystalline resin fine particles with a size of submicron order dispersed in the amorphous resin. In other words, the crystalline resin is made in a state that the molecules of the crystalline resin do not involve with the molecules of the amorphous resin, so that the crystalline resin and the amorphous resin exist independently from each other. As a result, it is assumed that it becomes possible to achieve to suppress the crystalline resin from being compatible to the amorphous resin.

Therefore, in the toner of the present invention, in a process of fixing toner images in an image forming process, even if the fixing temperature is set at a low temperature of 130° C. or less, it becomes possible to obtain a visual image with good image quality. In addition, during the storage of toner, or in a toner box in a developing device in an image forming process, it becomes possible to suppress occurrence of problems that toner aggregates to result in blocking, and a document offset phenomenon take place in an obtained visible image.

### [Production Method of Toner]

The production method of the toner of the present invention is not limited to specifically, and may include a suspension polymerization method, an emulsification aggregation method, a dissolution suspension method, and the like. However, the viewpoint of homogeneity in dispersion of a crystalline resin, the emulsification aggregation method is desirable.

The production method of the toner of the present invention according to the emulsification aggregation method is characterized by including an aggregating and heat fusion bonding process of mixing a water based dispersion liquid of binder resin fine particles and a water based dispersion liquid of colorant fine particles and aggregating and heat fusion bonding the binder resin fine particles and the colorant fine particles,

Here, in “water based dispersion liquid”, dispersion elements (fine particles) are dispersed in a water based medium, and in the water based medium, a major component (50 mass % or more) is composed of water. As components other than water, organic solvents which dissolve in water may be employed. Examples of the organic solvents include methanol, ethanol, isopropanol, butanol, acetone, methyl ethyl ketone, tetrahydrofuran, and the like. Of these, specifically preferable are alcohol system organic solvents which are solvents incapable of dissolving resin, such as methanol, ethanol, isopropanol, and butanol.

In the production method of the toner of the present invention, it is desirable that binder resin fine particles which constitutes the water based dispersion liquid of binder resin fine particles to be fed to the aggregation and heat fusion bonding process have a core/shell structure (hereafter, also referred to as “a specific core/shell structure”) in which the surface of a core particle composed of a crystalline resin is covered with a shell composed of an amorphous resin.

Herein, in the “specific core/shell structure”, a shell may merely cover a core particle. That is, the “specific core/shell structure” may include not only a configuration that a shell covers completely a core particle, but also a configuration that a shell covers partially a core particle. Further, the shell may have a multi layer structure of two or more layers composed of multi resins (amorphous resins) different in composition.

The binder resin fine particles having such a specific core/shell structure make the obtained toner to acquire easily a desired structure (structure of a binder resin), concretely, make a crystalline resin to be covered with an amorphous resin. As a result, in a process of fixing toner images in an image forming process of forming a visual image, even if toner has been subjected to heat histories, the crystalline resin is suppressed from being compatible to the amorphous resin, and the toner has desired heat resistance capabilities (heat-resistant strength).

As a method of producing binder resin fine particles having the specific core/shell structure, for example, employable is a method in which in a water based dispersion liquid of crystalline resin fine particles, the crystalline resin fine particles are made as nuclear particles (core particles) and shells are formed on respective nuclear particles by seed polymerization of a radical polymerizable monomer unit containing a styrene type monomer and a (meth)acrylate type monomer.

One concrete example of methods of producing the toner of the present invention comprises the following processes. According to the production method comprising such process, it becomes possible to obtain toner composed of toner particles. The toner particles have a core/shell structure constituted with core particles including at least a binder resin composed of a crystalline resin and an amorphous resin and a colorant and shells which cover the peripheral surfaces of the core particles and are made of a shell-use amorphous resin. Further, external additive gents are added to the toner particles.

(1) A crystalline resin particle dispersion liquid preparation process of preparing a dispersion liquid of crystalline resin fine particles;
(2) a preparation process of a binder resin fine particle dispersion liquid, in this process, in a water based medium, crystalline resin fine particles are made as basic particles, and shells composed of an amorphous resin are formed on the respective basic particles by the seed polymerization of a radical polymerizable monomer unit, so that binder resin fine particles are formed;
(3) a colorant fine particle dispersion liquid preparation process of preparing a water based dispersion liquid of colorant fine particles;
(4) an aggregation and heat fusion bonding process of forming colored particles by salting out, aggregating and heat fusion bonding the binder resin fine particles and colorant fine particles in a water based medium;
(5) a shell forming process of forming toner particles by covering the surface of the colored particles with a shell composed of an amorphous resin;
(6) a filtration and cleaning process of performing solid liquid separation for separating toner particles from the dispersion liquid of the toner particles, and removing surfactants and the like from the toner particles;
(7) a drying process of drying the toner particles having been subjected to the cleaning process; and
(8) an external additive agent addition process of adding external additive agents to the toner particle having been subjected to the drying process.

Hereafter, each process will be explained.

### (1) Crystalline Resin Particle Dispersion Liquid Preparation Process

This process is a process of preparing a dispersion liquid of crystalline fine particles. The crystalline resin fine particle dispersion liquid can be prepared in such a way that a crystalline resin synthesized by a proper procedure is dispersed in a water based medium by proper dispersion treatment.

Concretely, for example, in a method, a crystalline resin is dissolved in a solvent such as ethyl acetate, the resultant solution was emulsified and dispersed in a water based medium with a dispersion machine, and thereafter a de-solvent treatment is conducted to eliminate the above solvent, or in another method, a dispersion treatment is conducted in a water based medium under a temperature condition of 120° C. or more without employing any solvent.

In the case where a crystalline polyester resin is used as the crystalline resin, a dispersion liquid of crystalline resin fine particles may also be prepared in such a way that in a water based medium containing a long chain hydrocarbon group such as dodecyl benzene sulfonic acid and surfactants composed of a compound having an acid group, oil droplets composed of a composition containing a polyol compound and a multivalent carboxylic acid compound are formed and in the oil droplets, the polyol compound and the multivalent carboxylic acid compound are made to cause polycondensation so as to obtain a crystalline polyester resin (for example, refer to Japanese Unexamined Patent Publication No. 2006-337995, official report).

### (2) Preparation Process of a Binder Resin Fine Particle Dispersion Liquid

This process is a process of forming binder resin fine particles from crystalline resin fine particles and a radical polymerizable monomer unit to obtain an amorphous resin, thereby preparing a water based dispersion liquid of binder resin fine particles.

In order to obtain binder resin fine particles, according to a preferably employable method, in a dispersion liquid in which crystalline resin fine particles are dispersed in a water based medium, a radical polymerizable monomer unit to obtain an amorphous resin and a polymerization initiator are added, the crystalline resin fine particles are made as basic particles, and the radical polymerizable monomer is made to cause seed polymerization on the basic particles. In this case, it is desirable that crystalline resin fine particles used as basic particles have a volume-based median size of 40 to 280 nm. According to this method, shells composed of an amorphous resin obtained by the polymerization reaction of the radical polymerizable monomer unit are formed on the surfaces of the crystalline resin fine particles, that is, the binder resin fine particles having the specific core/shell structure are formed.

In the seed polymerization reaction system for obtaining binder resin fine particles, it is desirable that the added amount of the polymerization nature monomer unit is 5 to 70 mass % to the crystalline resin fine particles.

Further, as the polymerization initiator, a water soluble polymerization initiator may be used. Furthermore, as the water soluble polymerization initiator, for example, water soluble radical polymerization initiators, such as potassium persulfate and ammonium persulfate, may be used preferably.

In the seed polymerization reaction system for obtaining a binder resin fine particles, a generally usable chain transfer agent may be employed for the purpose of adjusting the molecular weight of an amorphous resin. Examples of the chain transfer agent include mercaptan, such as 2-chloroethanol, octylmercaptan, dodecyl mercaptan, and t-dodecyl mercaptan; and a styrene dimer.

It is desirable that the particle size of the binder resin fine particles obtained in this process is 50 300 nm as a volume-based median size. The particle size of the above-mentioned crystalline resin fine particles and the particle size of the binder resin fine particles are measured by a dynamic light scattering method with “micro-truck UPA-150 (manufactured by Nikkiso Co., Ltd.)”.

### (3) Colorant Fine Particle Dispersion Liquid Preparation Process

This process is a process of preparing a water based dispersion liquid of colorant fine particles.

The colorant fine particle dispersion liquid can be prepared by a dispersion treatment to disperse colorant fine particles in a water based medium. The dispersion treatment of colorant fine particles is conducted in water on a condition that the concentration of surfactants is made to a critical micelle concentration (CMC) or more. The dispersion machine used for the dispersion treatment of colorant fine particles is not limited to specifically, and for example, a stirring apparatus equipped with a rotor capable of rotating at high speed, an ultrasonic dispersion apparatus, a mechanical homogenizer, Cavitron, Menton Gaulin, a pressure type homogenizer, and the like may be employed.

The particle size of colorant fine particles in the colorant fine particle dispersion liquid obtained in this process is preferably 10 to 300 nm as a volume-based median size, more preferably 100 to 200 nm, and still more preferably 100 to 150 nm. This particle size of colorant fine particles can be controlled by adjustment of the magnitude of the abovementioned mechanical energy, for example.

Here, the surfactant is not limited to particularly. However, an ionic surfactant may be employed preferably. Preferable specific examples of the ionic surfactant include sulfonates (sodium dodecylbenzenesulfonate, arylated alkyl polyether sulfone sodium, 3,3-disulfone diphenylurea-4,4-diazobis-amino-8-naphthol 6-sulfone sodium, ortho-carboxybenzene-azo-dimethyl aniline, 2,2,5,5-tetra-methyl-triphenylmethane 4,4-diazobis-β-naphthol-6-sulfone sodium, etc.); Sulfuric ester salts (sodium dodecyl sulfate, sodium tetradecyl sulfate, pentadecylsodium sulfate, octylsodium sulfate, etc.); and fatty acid salts (sodium oleate, sodium laurate, sodium caprate, sodium caprylate, sodium caproate, potassium stearate, calcium oleate, etc.).

Further, a nonionic surfactant may be also employed, and specific examples of the nonionic surfactant include a polyethylene oxide, a polypropylene oxide, a combination of a polypropylene oxide and a polyethylene oxide, ester of polyethylene glycol and a higher fatty acid, alkylphenol polyethylene oxide, ester of a higher fatty acid and polyethylene glycol, ester of a higher fatty acid and a polypropylene oxide, sorbitan ester, and the like.

### (4) Aggregation and Heat Fusion Bonding Process

This process is a process of obtaining particles in an infinite form (nonspherical form) by salting out/heat fusion bonding (salting out and heat fusion bonding are caused simultaneously) binder resin fine particles and colorant fine particles, further adjusting the configuration of that particles, and thereby obtaining colored particles. In this aggregation and heat fusion bonding process, if needed, inner additive agent fine particles (fine particles having a number average primary particle size of about 10 to 1000 nm), such as release agent fine particles may subjected to aggregation and heat fusion bonding together with binder resin fine particles and colorant fine particles. Here, in the case where release agent fine particles are subjected to aggregation and heat fusion bonding together with binder resin fine particles and colorant fine particles, the addition of release agent fine particles into the salting out/heat fusion bonding system may be conducted in such a way that a dispersion liquid of release agent fine particles prepared by a proper method is in the salting out/heat fusion bonding system in the aggregation and heat fusion bonding process, or release agent fine particles are preliminarily added in the binder resin fine particle dispersion liquid obtained in the preparation process of the binder resin fine particle dispersion liquid.

In order to make binder resin fine particles and colorant fine particles to cause salting out/heat fusion bonding, salting-out agents (aggregating agents) with a critical aggregation concentration or more are added in a dispersion liquid in which binder resin fine particles and colorant fine particles are dispersed, and in addition, it is necessary to heat this dispersion liquid to the glass transition point of the binder resin fine particles, i.e., the glass transition point (Tg) of the binder resin or more. Further, in order to conduct heat fusion bonding, organic solvents capable of dissolving infinitely in water may be added.

A proper temperature range to cause salting out/heat fusion bonding is from (glass transition point Tg of binder resin fine particles+10° C.) to (glass transition point Tg of binder resin fine particles+50° C.), and specifically preferably from (glass transition point Tg of binder resin fine particles+15° C.) to (glass transition point Tg of binder resin fine particles+40° C.).

As the salting-out agent, alkaline metal salts and alkaline earth metal salts may be used. Examples of alkali metals constituting the salting-out agent include lithium, potassium, sodium, and the like, and examples of alkali earth metals constituting the salting-out agent include magnesium, calcium, strontium, barium, and the like. Among them, potassium, sodium, magnesium, calcium, and barium are preferable. Further, examples of counter ions (negative ion) of these alkaline metals and alkaline earth metals include chloride ion, bromide ion, iodide ion, carbonate ion, sulfate ion, and the like.

Examples of the organic solvents capable of dissolving infinitely in water include methanol, ethanol, 1-propanol, 2-propanol, ethylene glycol, glycerol, acetone, and the like. Among them, alcohols with 3 or less carbon atoms, such as methanol, ethanol, 1-propanol, and 2-propanol and the like may be preferable, and 2-propanol is specifically preferable.

The temperature of the dispersion liquid at the time of adding the salting-out agents in the dispersion liquid in which the binder resin fine particles and the colorant fine particles are dispersed is preferably the glass transition point (Tg) of binder resin fine particles or less.

If the temperature of the dispersion liquid at the time of adding the salting-out agents exceeds the glass transition point (Tg) of binder resin fine particles, it becomes difficult to control a particle size, which results in that excessively-large particles tend to be produced.

Accordingly, in this process, it is required that when the temperature of the dispersion liquid in which the binder resin fine particles and the colorant fine particles are dispersed is the glass transition point (Tg) of binder resin fine particles or less, the salting-out agents are added while the dispersion liquid is being stirred, thereafter, the heating of the dispersion liquid is started immediately, and the temperature of the dispersion liquid is increased to the glass transition point (Tg) of binder resin fine particles or more.

### (5) Shell Forming Process

This process is a process of covering the surfaces of the colored particles obtained in the aggregation and heat fusion bonding process with shells composed of amorphous resins, and thereby obtaining toner particles in which the shells are formed to cover the surfaces of core particles composed of the colored particles.

Concretely, for example, shell-use amorphous resin fine particles synthesized by a proper method are added into the dispersion liquid of core particles composed of colored particles, the shell-use amorphous resin fine particles for shells are made to aggregate on the surfaces of core particles so as to form shells covering the surfaces of core particles, and thereafter the resultant fine particles are ripened with heat energy (heating) such that the shape of the fine particles is adjusted, whereby toner particles are obtained.

### (6) Filtration and Cleaning Process

This process conducts a filtration treatment to filter the toner particles from the dispersion system of the toner particles obtained in the above process, and a cleaning treatment to remove extraneous matters such as surfactants, salting agents and the like from the filtered toner particles (cake-shaped aggregation product).

The filtration treatment is not limited to specifically, and for example, a centrifuge method, a reduced-pressure filtration method conducted by use of Nutsche, and a filtration method conducted by use of a filter press and the like may be employed.

### (7) Drying Process

This process is a process of conducting a dry treatment for the toner particle having been subjected to the cleaning treatment.

As a dryer used for the dry treatment, a spray dryer, a vacuum freeze dryer, a reduced-pressure dryer, and the like may be employed, and, concretely, it is desirable to use a still-standing shelf dryer, a portable shelf dryer, a fluidized bed dryer, a rotary drier, a stirring type dryer, and the like.

The moisture content of the toner particles having been subjected to the dry treatment is preferably 5 mass % or less, and more preferably 2 mass % or less.

Further, in this process, in the case where toner particles having been subjected to the dry treatment aggregate with each other by weak attracting force among the toner particles, the aggregate of the toner particles may be subjected to cracking treatment. Here, as a cracking treatment device, mechanical cracking devices, such as a jet mill, a Henschel mixer, a coffee mill, and a food processor may be employed.

### (8) External Additive Agent Addition Process

This process is a process of adding an external additive agent to toner particles having been subjected to the dry treatment.

As a device used to add an external additive agent, various well-known mixing devices, such as a Tumbler mixer, a Henschel mixer, a Nauta mixer, and a V shaped rotary mixer, are mentioned.

According to the above production method of the toner of the present invention, it is possible to produce the toner of the present invention which has excellent heat-resistance storage stability (blocking resistance) and document offset resistant as well as low temperature fixing ability.

As mentioned above, the embodiment of the production method of the toner of the present invention has been described. However, the present invention is not limited to the abovementioned embodiment and may be applied with various modifications.

### Example

Hereafter, although concrete examples of the present invention are described, the present invention is not limited to these examples.

### [Synthesis Example 1 of a Crystalline Polyester Resin]

Into a 5-L reaction container equipped with a stirring device, a temperature sensor, a cooling tube, and a nitrogen gas introducing device, 220 parts by mass of sebacic acid (molecular weight: 202.25) as a multivalent carboxylic acid compound and 157 parts by mass of 1,4-butanediol (molecular weight: 144.21) as a polyol compound were charged, and an inner temperature was risen to 190° C. over one hour while these compounds were being stirred, and after these compounds were confirmed to be the uniformly-stirred condition, Ti(OBu)4 as catalyst was added in an amount of 0.003 mass % to the charged amount of the multivalent carboxylic acid compound into these stirred compounds. Subsequently, while produced water was being distilled away, the inner temperature was risen from 190° C. to 240° C., further, on the condition of a temperature of 240° C., a dehydration condensation reaction were continued over 6 hours so as to conduct polymerization, whereby a crystalline polyester resin (hereafter, also referred to as “Crystalline polyester resin (1)”) was obtained. From the obtained Crystalline polyester resin (1), a DSC curve was obtained on the condition of a temperature rising rate of 10° C./minute by use of a differential scanning calorimeter “Diamond DSC” (manufactured by Perkin-Elmer), and a melting point (Tm) was measured by a technique to measure an endothermic peak top temperature, which resulted in that it was 64° C. Further, molecular weight was measured by GPC (“HLC-8120GPC” (manufactured by Tosoh Corporation)), which resulted in that a number average molecular weight was 3,600 as standard styrene conversion.

### [Synthesis Example 2 of a Crystalline Polyester Resin]

A crystalline polyester resin (hereafter, also referred to as “Crystalline polyester resin (2)”) was obtained in the same way as that in Synthesis Example 1 of the crystalline polyester resin except that 68 parts by mass of ethylene glycol (molecular weight: 62.07) was used as the multivalent carboxylic acid compound in Synthesis Example 1 of a crystalline polyester resin. For the obtained “Crystalline polyester resin (2)”, a melting point (Tm) was measured in the same technique for Synthesis Example 1 of a crystalline polyester resin, resulted in 75 64° C., and also molecular weight was measured, resulted in a number average molecular weight of 2,800 as standard styrene conversion.

### [Preparation Example 1 of Dispersion Liquid of Crystalline Polyester Resin Fine Particles]

Thirty parts by mass of the crystalline polyester resin (1) was melted, and transferred in the molten state at a transfer rate of 100 parts by mass per minute to an emulsification dispersion device “Cavitron CD 1010” (manufactured by EuroTech). Further, 70 parts by mass of reagent aqueous ammonia was diluted with ion exchange water in an aqueous solvent tank so as to obtain a diluted ammonia water with a concentration of 0.37 mass %, and at the same time with the transferring of the crystalline polyester resin (1) in the molten state, the diluted ammonia water was transferred at a transfer rate of 0.1 liter/minute to the emulsification dispersion device “Cavitron CD 1010” (manufactured by EuroTech) while being heated at 100° C. with a heat exchange device. At the time of the above transferring, the emulsification dispersion device “Cavitron CD1010” (manufactured by EuroTech) was operated on the conditions of a rotor's rotational speed of 60 Hz and a pressure of 5 kg/cm², whereby a dispersion liquid of the crystalline polyester resin fine particles (hereafter, also referred to as “Crystalline resin particle dispersion liquid (1)”) with a volume-based median size of 200 nm and a solid content of 30 parts by mass was prepared.

### [Preparation Example 2 of Dispersion Liquid of Crystalline Polyester Resin Fine Particles]

A dispersion liquid of crystalline polyester resin fine particles (hereafter, also referred to as “Crystalline resin particle dispersion liquid (2)”) with a volume-based median size of 250 nm and a solid content of 30 parts by mass was prepared in the same way as that in Preparation Example 1 of dispersion liquid of crystalline polyester resin fine particles except that the crystalline polyester resin (2) was used in place of the crystalline polyester resin (1).

### [Preparation Example 1 of a Dispersion Liquid of Release Agent Fine Particles]

Sixty parts by mass of behenic acid behenate (melting point: 71° C.) as a release agent, 5 parts by mass of an ionic surfactant “Neogene RK” (manufactured by Dai-ichi Kogyo Seiyaku Co., Ltd.) and 240 parts by mass of ion-exchange water were mixed, and a resultant mixture solution was heated to 95° C., dispersed sufficiently by use of a homogenizer “ultra tack T50” (manufactured by IKA Corporation), and then subjected to a dispersion treatment by use of a pressure discharge type Gaulin homogenizer, whereby a dispersion liquid of release agent fine particles (hereafter, also referred to as Release agent particle dispersion liquid (1) with a volume-based average size of 240 nm and a solid content of 20 parts by mass was prepared.

### [Preparation Example 1 of Water-Based Dispersion Liquid of Binder Resin Fine Particles]

Into a 5 L reaction container equipped with a stirring device, a temperature sensor, a cooling tube, and a nitrogen gas introducing device, 1450 parts by mass of Crystalline resin particle dispersion liquid (1), 650 parts by mass of Release agent particle dispersion liquid (1) and 1252 parts by mass of ion-exchange water were charged, further, a polymerization initiator solution in which 10.3 parts by mass of potassium persulfate was dissolved in 210 parts by mass of ion-exchange water was added. Subsequently, on the temperature condition of 80° C., a polymerizable monomer mixed liquid composed of a radical polymerizable monomer unit composed of 274.1 parts by mass of styrene, 139.2 parts by mass of n-butyl acrylate and 21.8 parts by mass of methacrylic acid and 8.2 parts by mass of n-octyl mercaptan was made to drop over 2 hours, thereafter, further heated and stirred at 80° C. over 2 hours so as to conduct seed polymerization. After the polymerization has been completed, the resultant liquid was cooled to 28° C., whereby prepared was water-based dispersion liquid (hereafter, also referred to as “Binder resin particle dispersion liquid (1)”) of binder resin fine particles having a core/shell structure in which a core particle composed of Crystalline polyester resin (1) was covered with amorphous resin. For the obtained Binder resin particle dispersion liquid (1), the particle size of binder resin fine particles was measured with “Micro-truck UPA-150” (manufactured by Nikkiso Co., Ltd.), which resulted in that an average particle size was 220 nm. The molecular weight of the binder resin constituting the binder resin fine particles was measured by GPC measurement, which resulted in that a weight average molecular weight was 19,500. Further, the glass transition point of the binder resin fine particles relating to the Binder resin particle dispersion liquid (1), i.e., the glass transition point of the amorphous resin constituting the binder resin fine particles was measured by DSC measurement, which resulted in that it was 35° C.

### [Preparation Example 2 of Water-Based Dispersion Liquid of Binder Resin Fine Particles]

Water-based dispersion liquid (hereafter, also referred to as “Binder resin particle dispersion liquid (2)”) of binder resin fine particles having a core/shell structure was prepared in the same way as that in Preparation Example 1 of water-based dispersion liquid of binder resin fine particles except that Crystalline resin particle dispersion liquid (2) was used in place of Crystalline resin particle dispersion liquid (1) in Preparation Example 1 of water-based dispersion liquid of binder resin fine particles. For the obtained Binder resin particle dispersion liquid (2), the particle size of binder resin fine particles was measured in the same way in Preparation Example 1 of water-based dispersion liquid of binder resin fine particles, which resulted in that an average particle size was 265 nm. The molecular weight of the binder resin constituting the binder resin fine particles was measured, which resulted in that a weight average molecular weight was 19,800. Further, the glass transition point of the binder resin fine particles (the glass transition point of the amorphous resin constituting the binder resin fine particles) was measured, which resulted in that it was 35° C.

### [Preparation Example 3 of Water-Based Dispersion Liquid of Binder Resin Fine Particles]

Water-based dispersion liquid (hereafter, also referred to as “Binder resin particle dispersion liquid (3)”) of binder resin fine particles having a core/shell structure was prepared in the same way as that in Preparation Example 1 of water-based dispersion liquid of binder resin fine particles except that a mixed liquid composed of a radical polymerizable monomer unit composed of 319.8 parts by mass of styrene, 93.5 parts by mass of n-butyl acrylate and 21.8 parts by mass of methacrylic acid and 8.2 parts by mass of n-octyl mercaptan was used as the polymerizable monomer mixed liquid in Preparation Example 1 of water-based dispersion liquid of binder resin fine particles. For the obtained Binder resin particle dispersion liquid (3), the particle size of binder resin fine particles was measured in the same way in Preparation Example 1 of water-based dispersion liquid of binder resin fine particles, which resulted in that an average particle size was 230 nm. The molecular weight of the binder resin constituting the binder resin fine particles was measured, which resulted in that a weight average molecular weight was 19,600. Further, the glass transition point of the binder resin fine particles (the glass transition point of the amorphous resin constituting the binder resin fine particles) was measured, which resulted in that it was 55° C.

### [Preparation Example 4 of Water-Based Dispersion Liquid of Binder Resin Fine Particles]

Water-based dispersion liquid (hereafter, also referred to as “Binder resin particle dispersion liquid (4)”) of binder resin fine particles having a core/shell structure was prepared in the same way as that in Preparation Example 1 of water-based dispersion liquid of binder resin fine particles except that a mixed liquid composed of a radical polymerizable monomer unit composed of 304.6 parts by mass of styrene, 108.8 parts by mass of n-butyl acrylate and 21.8 parts by mass of methacrylic acid and 8.2 parts by mass of n-octyl mercaptan was used as the polymerizable monomer mixed liquid in Preparation Example 1 of water-based dispersion liquid of binder resin fine particles. For the obtained Binder resin particle dispersion liquid (4), the particle size of binder resin fine particles was measured in the same way in Preparation Example 1 of water-based dispersion liquid of binder resin fine particles, which resulted in that an average particle size was 235 nm. The molecular weight of the binder resin constituting the binder resin fine particles was measured, which resulted in that a weight average molecular weight was 19,400. Further, the glass transition point of the binder resin fine particles (the glass transition point of the amorphous resin constituting the binder resin fine particles) was measured, which resulted in that it was 48° C.

### [Preparation Example 5 of Water-Based Dispersion Liquid of Binder Resin Fine Particles]

Water-based dispersion liquid (hereafter, also referred to as “Binder resin particle dispersion liquid (5)”) of binder resin fine particles having a core/shell structure was prepared in the same way as that in Preparation Example 1 of water-based dispersion liquid of binder resin fine particles except that a mixed liquid composed of a radical polymerizable monomer unit composed of 254.5 parts by mass of styrene, 158.8 parts by mass of n-butyl acrylate and 21.8 parts by mass of methacrylic acid and 8.2 parts by mass of n-octyl mercaptan was used as the polymerizable monomer mixed liquid in Preparation Example 1 of water-based dispersion liquid of binder resin fine particles. For the obtained Binder resin particle dispersion liquid (5), the particle size of binder resin fine particles was measured in the same way in Preparation Example 1 of water-based dispersion liquid of binder resin fine particles, which resulted in that an average particle size was 225 nm. The molecular weight of the binder resin constituting the binder resin fine particles was measured, which resulted in that a weight average molecular weight was 18,900. Further, the glass transition point of the binder resin fine particles (the glass transition point of the amorphous resin constituting the binder resin fine particles) was measured, which resulted in that it was 27° C.

### [Preparation Example 6 of Water-Based Dispersion Liquid of Binder Resin Fine Particles]

Water-based dispersion liquid (hereafter, also referred to as “Binder resin particle dispersion liquid (6)”) of binder resin fine particles having a core/shell structure was prepared in the same way as that in Preparation Example 1 of water-based dispersion liquid of binder resin fine particles except that a mixed liquid composed of a radical polymerizable monomer unit composed of 237.1 parts by mass of styrene, 176.2 parts by mass of n-butyl acrylate and 21.8 parts by mass of methacrylic acid and 8.2 parts by mass of n-octyl mercaptan was used as the polymerizable monomer mixed liquid in Preparation Example 1 of water-based dispersion liquid of binder resin fine particles. For the obtained Binder resin particle dispersion liquid (6), the particle size of binder resin fine particles was measured in the same way in Preparation Example 1 of water-based dispersion liquid of binder resin fine particles, which resulted in that an average particle size was 215 nm. The molecular weight of the binder resin constituting the binder resin fine particles was measured, which resulted in that a weight average molecular weight was 18,800. Further, the glass transition point of the binder resin fine particles (the glass transition point of the amorphous resin constituting the binder resin fine particles) was measured, which resulted in that it was 20° C.

### [Preparation Example 7 of Water-Based Dispersion Liquid of Binder Resin Fine Particles]

### (1) Preparation of Nuclear Particles (First Stage Polymerization)

Into a 5000-ml separable flask equipped with a stirring device, a temperature sensor, a cooling tube, and a nitrogen gas introducing device, charged was a surfactant solution (water-based medium) in which 7.08 g of anionic type surfactant (dodecylspecific sulfonate: SDS) was dissolved in 3010 g of ion exchange water, and an inner temperature was risen to 60° C. while the solution was being stirred at a stirring rate of 230 rpm under nitrogen gas current. Into the surfactant solution, added was an initiator solution in which 9.2 g of polymerization initiator (potassium persulfate: KPS) was dissolved in 200 g of ion exchange water, and after the temperature was made to 75° C., a monomer mixed liquid composed of 70.1 g of styrene, 19.9 g of n-butyl acrylate, and 10.9 g of methacrylic acids was dropped over one hour. The resultant system was heated at 75° C. over two hours and stirred so as to perform polymerization (first stage polymerization), whereby a nuclear particle dispersion liquid (hereafter, also referred to as “Latex (H)”) was prepared.

### (2) Formation of an Intermediate Layer (Second Stage Polymerization)

In a flask equipped with a stirring device, 56.0 g of behenic acid behenate and 72 g of Crystalline polyester resin (1) were added into a monomer mixed liquid composed of 89.5 g of styrene, 46.2 g of n-butyl acrylate, 6.4 g of methacrylic acids, and 5.6 g of n-octyl-3-mercaptopropionic acid ester, and dissolved while being heated at 20° C., whereby a monomer solution was prepared. On the other hand, a surfactant solution in which 1.6 g of anionic type surfactant (SDS) was dissolved in 2700 ml of ion exchange water was heated to 60° C., and into this surfactant solution, the above Latex (H) being a nuclear particle dispersion liquid was added in an amount of 28 gas solid component conversion. Thereafter, the resultant liquid was dispersed by a mechanical dispersion machine “CLEAMIX” (manufactured by M Technique Co., Ltd.) equipped with a circulating passage, whereby a dispersion liquid (emulsified liquid) including emulsified particles (oil droplets) of a monomer solution was prepared. Subsequently, into this dispersion liquid (emulsified liquid), added were an initiator solution in which 5.1 g of polymerization initiator (KPS) was dissolved in 240 ml of ion exchange water and 750 ml of ion exchange water, and the resultant system was heated at 60° C. over three hours while being stirred, whereby polymerization (second stage polymerization) was performed.

### (3) Formation of an Outer Layer (Third Stage Polymerization)

Into the thus-obtained resin particle dispersion liquid, added was an initiator solution in which 7.4 g of polymerization initiator (KPS) was dissolved in 200 ml of ion exchange water, and under a temperature condition of 60° C., a monomer mixed liquid composed of 262.6 g of styrene, 132.5 g of n-butyl acrylate, 15.3 g of methacrylic acid, and 10.4 g of n-octyl-3-mercaptopropionic acid ester was dropped over one hour. After the dropping has been completed, the resultant liquid was heated and stirred over two hours so as to perform polymerization, and then cooled to 28° C., whereby a dispersion liquid of composite resin particles (hereafter, also referred to as “Composite resin particle dispersion liquid (1)”) was obtained. The composite resin particles constituting the obtained Composite resin particle dispersion liquid (1) have a peak molecular weight in 138,000, 80,000, and 13,000, and the composite resin particles have a weight average particle size of 180 nm and a glass transition point of 34° C.

### [Preparation Example 1 of a Dispersion Liquid of Colorant Fine Particles]

First, 11.5 parts by mass of n-dodecyl sulfuric acid sodium was stirred and dissolved in 160 parts by mass of ion exchange water, and then while this solution was being stirred, 25 parts by mass of C.I. Pigment Blue 15:3 as a colorant was added gradually. Thereafter, the resultant liquid was subjected to dispersion treatment by use of a stirring device “CLEAMIX W-motion CLM-0.8” (manufactured by M Technique Co., Ltd.), whereby a water based dispersion liquid (hereafter, also referred to as “Colorant particle dispersion liquid (1)”) of the colorant fine particles having a volume-based median size of 158 nm was prepared. The volume-based median size of the colorant fine particles was measured by use of “MICROTRAC UPA 150” (manufactured by Honeywell Corporation) on the measurement conditions of sample refractive index: 1.59, sample specific gravity: 1.05 (spherical particle conversion), solvent refractive index: 1.33, solvent viscosity: 0.797 (30° C.) and 1.002 (20° C.), and zero-point adjustment conducted on the condition that ion exchange water was put into a measuring cell.

### [Preparation Example 1 of Resin Particles for Shell]

Into a 5-L reaction container equipped with a stirring device, a temperature sensor, a cooling tube, and a nitrogen gas introducing device, 600 parts by mass of water was charged, and an inner temperature was risen to 70° C. while the water was being stirred at a stirring rate of 230 rpm under nitrogen gas current. Thereafter, 119 parts by mass of styrene, 33 parts by mass of n-butyl acrylate, 8 parts by mass of methacrylic acid and 4.5 parts by mass of n-octyl mercaptan were added, and fluffier an aqueous solution in which 3 parts by mass of polymerization initiator (potassium persulfate) was dissolved in 40 parts by mass of ion-exchange water was added. Subsequently, the resultant system was heated and stirred at 70° C. over 10 hours, whereby resin particles for shell (hereafter, also referred to as “Shell-use resin particles (1)”) were prepared. The obtained Shell-use resin particles (1) had a weight average molecular weight (Mw) of 13,200, a number average particle size of 221 nm, and a glass transition point of 55.4° C.

### [Production Example 1 of Toner]

Into a zebra flask equipped with a stirring device, a temperature sensor, a cooling tube, and a nitrogen gas introducing device, 400 parts by mass (solid content conversion) of Binder resin particle dispersion liquid (1), 1500 parts by mass of ion-exchange water and 165 parts by mass of colorant particle dispersion liquid (1) were charged and the liquid temperature was adjusted to 30° C., thereafter, PH was adjusted to 10 by the addition of a sodium hydroxide aqueous solution with a concentration of mass %. Subsequently, an aqueous solution in which 54.3 parts by mass of magnesium chloride hexahydrate was dissolved in 54.3 parts by mass Of ion-exchange water was added. Thereafter, the resultant system was heated to 60° C., whereby binder resin fine particles and colorant fine particles started aggregation reaction. After the aggregation reaction was started, sampling was conducted periodically, and the volume-based median size of the colorant particles was measured by use of a particle size distribution measuring apparatus “COULTER Multisizer 3” (manufactured by Beckman Coulter Inc.). When the volume-based median size became 5.8 μm, 200 parts by mass of Shell-use resin particles (1) was added, further, the aqueous solution in which 2 parts by mass of magnesium chloride hexahydrate was dissolved in 2 parts by mass Of ion-exchange water was added over 10 minutes. The stirring was continued until the volume-based median size became 6.0 μm, whereby a shell was formed on each colorant particle. For the colorant particles on which shells were formed, the degree of circularity was measured by use of a flow type particle image analysis apparatus “FPIA-2100” (manufactured by Sysmex Corporation), which resulted in that it was 0.951. Thereafter, the resultant system was heated to 65° C., stirring was continued for four hours, and when the degree of circularity became 0.976 in the measurement by the flow type particle image analysis apparatus “FPIA-2100” (manufactured by Sysmex Corporation), the resultant system was cooled to 30° C. on the condition of 6° C./minute so as to stop the reaction, whereby a dispersion liquid of colorant particles having a core/shell structure was obtained.

The thus-obtained dispersion liquid of colorant particles was subjected to solid-liquid separation by use of a basket type centrifugal machine “MARK III model number 60×40” (manufactured by Matsumoto Kikai Co., Ltd.), whereby wet cake was formed. This wet cake was repeatedly subjected to washing and solid-liquid separation until the electrical conductivity of filtrate of the basket type centrifugal machine became 15 μs/cm. Subsequently, the resultant solid was sprayed with are current with a temperature of 40° C. and a humidity of 20% RH by use of “Flash jet dryer” (manufactured by Seishin Enterprise CO., LYD.). Such a dry treatment was continued until the moisture content became 0.5 mass %, and then resultant solid was cooled to 24° C., whereby toner particles (hereafter, also referred to as “Toner particles (1)”) were obtained.

To the obtained toner particles (1), 1 mass % of hydrophobic silica particles were added, and were mixed over 20 minutes by use of Henschel mixer at the peripheral speed of rotary wings being 24 m/s. Further, the toner particles (1) were made to pass through a screen mesh so as to be provided with external additives, whereby toner (hereafter, also referred to as “Toner (1)” was obtained. For the obtained Toner (1), a glass transition point was measured by DSC measurement, which resulted in that it was 37° C. In Toner (1), with the addition of hydrophobic silica particles, the shape and particle size of toner particles did not change.

### [Production Example 2 of Toner]

Toner (hereafter, also referred to as “Toner (2)” was obtained in the same way as that in Production Example 1 of toner except that Binder resin particle dispersion liquid (4) was used in place of Binder resin particle dispersion liquid (1) in Production Example 1 of toner. For the obtained Toner (2), a glass transition point was measured by DSC measurement, which resulted in that it was 49° C.

### [Production Example 3 of Toner]

Toner (hereafter, also referred to as “Toner (3)” was obtained in the same way as that in Production Example 1 of toner except that Binder resin particle dispersion liquid (5) was used in place of Binder resin particle dispersion liquid (1) in Production Example 1 of toner. For the obtained Toner (3), a glass transition point was measured by DSC measurement, which resulted in that it was 29° C.

### [Production Example 4 of Toner]

Toner (hereafter, also referred to as “Toner (4)” was obtained in the same way as that in Production Example 1 of toner except that Binder resin particle dispersion liquid (2) was used in place of Binder resin particle dispersion liquid (1) in Production Example 1 of toner. For the obtained Toner (4), a glass transition point was measured by DSC measurement, which resulted in that it was 36° C.

### [Production Example 5 of Toner]

Toner (hereafter, also referred to as “Toner (5)” was obtained in the same way as that in Production Example 1 of toner except that Binder resin particle dispersion liquid (3) was used in place of Binder resin particle dispersion liquid (1) in Production Example 1 of toner. For the obtained Toner (5), a glass transition point was measured by DSC measurement, which resulted in that it was 57° C.

### [Production Example 1 of Comparative Toner]

Comparative toner (hereafter, also referred to as “Comparative toner (1)” was obtained in the same way as that in Production Example 1 of toner except that Binder resin particle dispersion liquid (6) was used in place of Binder resin particle dispersion liquid (1) in Production Example 1 of toner. For the obtained Comparative toner (1), a glass transition point was measured by DSC measurement, which resulted in that it was 22° C.

### [Production Example 2 of Comparative Toner]

Comparative toner (hereafter, also referred to as “Comparative toner (2)” was obtained in the same way as that in Production Example 1 of toner except that Binder resin particle dispersion liquid (7) was used in place of Binder resin particle dispersion liquid (1) in Production Example 1 of toner. For the obtained Comparative toner (2), a glass transition point was measured by DSC measurement, which resulted in that it was 35° C.

### <Measurement of a Ratio (Q2/Q1)>

For each of the obtained Toner (1) to Toner (5) and Comparative toner (1) and Comparative toner (2), the ratio (Q2/Q1) was measured with the abovementioned technique by use of a differential scanning calorimeter “Diamond DSC” (manufactured by Perkin-Elmer). The measurement results are shown in Table 1.

### <Production of Developer>

Each of the obtained Toner (1) to Toner (5) and Comparative toner (1) and Comparative toner (2) was mixed with silicone resin-covered ferrite carrier with a volume-based median size of 60 μm by use of a V type mixer such that the concentration of toner became 6 mass %, whereby Developer (1) to Developer (5) and Comparative developer (1) and Comparative developer (2) were produced.

### <Evaluation of Toner>

The following evaluation was conducted for Toner (1) to Toner (5) and Comparative toner (1) and Comparative toner (2) constituting respectively the obtained Developer (1) to Developer (5) and Comparative developer (1) and Comparative developer (2). The results are shown in Table 1.

### (1) Evaluation of Low Temperature Fixing Ability

In the evaluation, a commercially available compound machine “bizhub PRO C6500” (manufactured by Konica Minolta Business Technologies) was used as an image forming apparatus, and in this machine, Developer (1) to Developer (5) and Comparative developer (1) and Comparative developer (2) were mounted respectively. The surface temperature of a fixing heating member in a fixing device of a heating roller fixing type was changed with an interval of 5° C. within a range of 80 to 150° C., and for each surface temperature, image formation was conducted by use of paper sheets with a weight of 350 g as an image recording sheet under an environment of the normal temperature and normal humidity (a temperature of 20° C., a humidity of 50% RH) so as to obtain a solid image with an image optical density as a visual image. Each of the obtained solid images (visual images) was folded by a folding machine, and the solid images on the folded state were sprayed with air with a pressure of 0.35 MPa. Thereafter, the state of the folded line portion was evaluated with five ranks based on the following criteria while referring boundary samples, and the surface temperature of the fixing heating member with which a solid image evaluated at Rank 3 was obtained, was determined as a lower limit fixing temperature.

Rank 1: There was large image peel-off (also there was peel-off on portions other than the folded line portion).

Rank 2: There was thick line-shaped peel-off along the folded line portion.

Rank 3: There was thin line-shaped peel-off along the folded line portion.

Rank 4: There was peel-off at a part of the folded line portion along the folded line portion.

Rank 5: There was peel-off not at all.

### (2) Heat-Resistance Storage Stability (Blocking Resistance)

Into a glass bottle with a volume of 10 ml and an inside diameter of 21 mm, 0.5 g of each of respective toners constituting Developer (1) to Developer (5) and Comparative developer (1) and Comparative developer (2) was put, and the glass bottle was closed with a lid. Then, the glass bottles was shook 600 times by use of a shaking device “Tapdenser KYT-2000” (manufactured by Seishin Enterprise CO., LYD.), and the glass bottle was left unattended for two hours on the lid-opened condition under the environment of a temperature of 55° C. and a humidity of 35% RH. Thereafter, toner was taken out from the glass bottle, and placed on a screen mesh with 48 meshes (mesh size: 350 μm) with care such that aggregation substance of toner is not crushed. The screen mesh was set on “powder tester” (manufactured by HOSOKAWA MICRON CORP.), and fixed with a pressing bar and a knob nut, thereafter, applied with vibration for 10 seconds with a vibration strength to cause a feeding width of 1 mm. After the application of vibration, the amount of toner (amount of remaining toner) remaining on the screen mesh was measure, and the toner aggregation rate was calculated by the following formula (2). On the basis of the obtained toner aggregation rate, the case where the toner aggregation rate was less than 15% was evaluated as “A”, because the heat-resistance storage stability was extremely good; the case where the toner aggregation rate was 15% or more and 20% or less was evaluated as “B”, because the heat-resistance storage stability was good; and the case where the toner aggregation rate exceeded 20% was evaluated as “C”, because the heat-resistance storage stability was bad and there was problems in practical use. In this evaluation, the case where the toner aggregation rate was 20% or less was an acceptance level.

Toner aggregation rate=(Amount (g) of toner remaining on the screen mesh/0.5 of)×100 Formula (2)

### (3) Evaluation of Document Offset Resistance

A commercially available compound machine “bizhub PRO C6500” (manufactured by Konica Minolta Business Technologies) provided with its exclusive finisher “FS-608” (manufactured by Konica Minolta Business Technologies) was used as an image forming apparatus, and the automatic product preparation test for 20 sets of inner-bound prints (one set: 5 sheets) was conducted repeatedly 50 times. In this automatic product preparation test, a pixel rate per one page was set to 50% and a paper sheet with a weight of 64 g was used as an image recording sheet (transfer sheet). The produced inner-bound prints were cooled to a room temperature with natural cooling, and all pages of the inner-bound prints were visually checked, and a page having the largest degree of image defect in the visual image was evaluated based on the following criteria. In this evaluation, Rank 3 and Rank 4 were acceptable levels.

Rank 1:

On the image portions, image defects, such as white omission, took place, and even on the non image portions, clear image transfer took place. Accordingly, the document offset resistance was very poor.

Rank 2:

Disorder was caused in paper sheet alignment so that a front edge was cut out on the condition that images are inclined on some pages, or image defects and image transfer were caused as problems in practical use, for example, trace of image adhesion took place as uneven brightness at some places on image portions. Accordingly, the document offset resistance was poor.

Rank 3:

When pages in which image portions were superimposed to each other were turned up, some clear sounds were generated. However, in image portions and no image portions, there were not image defects and image transfer evaluated problems in practical use. Accordingly, the document offset resistance was good.

Rank 4:

In both image portions and no image portions, there were image defects and image transfer not at all. Accordingly, the document offset resistance was very good.

TABLE 1

| | | | | | | | | Evaluation | | | |
|---|---|---|---|---|---|---|---|---|---|---|---|
| | | | | | | | | Low | | | |
| | Binder resin particle provided to an aggregation and heat fusion | | | | | | | temperature | | | |
| | bonding process | | | | | | | fixing | | | |
| | Binder | | | | Amorphous | | | capability | | | |
| | resin | Crystalline resin | | | resin | Glass | | Lower limit | Heat-resistance storage | | |
| | particle | Multivalent | | Melting | Glass | transition | | fixing | stability | | Document |
| | dispersion | carboxylic | Multivalent | point | transition | point | Ratio | temperature | Aggregation | Evalua- | offset |
| | liquid No. | acid | alcohol | (° C.) | point (° C.) | (° C.) | (Q₂/Q₁) | (° C.) | rate (%) | tion | resistance |
| Toner 1 | 1 | Sebacic acid | 1,4-butanediol | 64 | 35 | 37 | 0.92 | 110 | 12 | AA | Rank 3 |
| Toner 2 | 4 | Sebacic acid | 1,4-butanediol | 64 | 48 | 49 | 0.94 | 115 | 8 | AA | Rank 4 |
| Toner 3 | 5 | Sebacic acid | 1,4-butanediol | 64 | 27 | 29 | 0.86 | 105 | 16 | A | Rank 3 |
| Toner 4 | 2 | Sebacic acid | Ethylene glycol | 74 | 35 | 36 | 0.90 | 110 | 10 | AA | Rank 4 |
| Toner 5 | 3 | Sebacic acid | 1,4-butanediol | 64 | 55 | 57 | 0.95 | 130 | 4 | AA | Rank 4 |
| Comp. 1 | 6 | Sebacic acid | 1,4-butanediol | 64 | 20 | 22 | 0.65 | 105 | 78 | C | Rank 1 |
| Comp. 2 | 7 | Sebacic acid | 1,4-butanediol | 64 | 34 | 35 | 0.15 | 100 | 34 | C | Rank 1 |

Comp.: Comparative toner

The abovementioned preferred embodiment of the present invention may be summarized as follows.

The toner of the present invention for developing electrostatic latent images is toner for developing electrostatic latent images which contains at least a binder resin and a colorant, wherein the binder resin is composed of an amorphous resin obtained from a radical polymerizable monomer unit containing a styrene type monomer and a (meth)acrylate type monomer and a crystalline resin, and a ratio (Q2/Q1) is 0.85 or more, where Q1 represents an amount of absorbed heat based on an endothermic peak (heat absorption peak) derived from the crystalline resin in a first temperature rising process from 0° C. to 200° C. in a measurement with a differential scanning calorimeter, and Q2 represents an amount of absorbed heat based on an endothermic peak derived from the crystalline resin in a second temperature rising process from 0° C. to 200° C.

In the toner of the present invention for developing electrostatic latent images, it is desirable that a glass transition point is 25 to 50° C.

In the toner of the present invention for developing electrostatic latent images, it is desirable that the crystalline resin is a crystalline polyester resin.

A production method of the toner of the present invention for developing electrostatic latent images comprises an aggregating and heat fusion bonding process of mixing a water based dispersion liquid of binder resin fine particles and a water based dispersion liquid of colorant fine particles and aggregating and heat fusion bonding the binder resin fine particles and the colorant fine particles, wherein the obtained toner contains at least a binder resin and a colorant, the binder resin is composed of an amorphous resin obtained from a radical polymerizable monomer unit containing a styrene type monomer and a (meth)acrylate type monomer and a crystalline resin, and a ratio (Q2/Q1) is 0.85 or more, where Q1 represents an amount of absorbed heat based on an endothermic peak (heat absorption peak) derived from the crystalline resin in a first temperature rising process from 0° C. to 200° C. in a measurement with a differential scanning calorimeter, and Q2 represents an amount of absorbed heat based on an endothermic peak derived from the crystalline resin in a second temperature rising process from 0° C. to 200° C.

In the production method of the toner of the present invention for developing electrostatic latent images, it is desirable that the binder resin fine particles have a core/shell structure in which a surface of a core composed of a crystalline resin is covered with a shell composed of an amorphous resin.

In the production method of the toner of the present invention for developing electrostatic latent images, it is desirable that the amorphous resin constituting the binder resin fine particles has a glass transition point of 25 to 50° C. and the crystalline resin constituting the binder resin fine particles has a melting point of 40 to 95° C.

In the production method of the toner of the present invention for developing electrostatic latent images, it is desirable that the core/shell structure is formed such that in the water based dispersion liquid of the crystalline resin fine particles, a shell is formed on a core particle of a crystalline resin fine particle by seed polymerization of a radical polymerizable monomer unit containing a styrene type monomer and a (meth)acrylate type monomer.

In the production method of the toner of the present invention for developing electrostatic latent images, it is desirable that a surface of a colorant particle obtained in the aggregating and heat fusion bonding process is covered with a shell composed of an amorphous resin.

According to the toner of the present invention for developing electrostatic latent images, the binder resin is composed of an amorphous resin and a crystalline resin and the crystalline resin is suppressed from dissolving into the amorphous resin at the time of being subjected to heat histories, whereby the binder resin is provided with desired heat resistance properties (heat resistance strength). Therefore, since the glass transition point of toner does not fall greatly due to the fact that a crystalline resin is not compatible with or does not dissolve into an amorphous resin, it becomes possible to obtain a low temperature fixing ability, in addition, excellent heat resistance storage stability (blocking resistance) and document offset resistance.

According to the production method of the toner of the present invention for developing electrostatic latent images, it is possible to produce easily toner for developing electrostatic latent images with a low temperature fixing ability, excellent heat resistance storage stability (blocking resistance) and document offset resistance.

What is claimed is:

1. A toner for developing electrostatic latent images, including:
a binder resin, and
a colorant,
wherein the binder resin includes an amorphous resin obtained from a radical polymerizable monomer unit containing a styrene type monomer and a (meth)acrylic ester type monomer and a crystalline resin, and a ratio (Q2/Q1) is 0.85 or more, where Q1 represents an amount of absorbed heat based on an endothermic peak derived from the crystalline resin in a first temperature rising process from 0° C. to 200° C. in measurement with a differential scanning calorimeter, and Q2 represents an amount of absorbed heat based on an endothermic peak derived from the crystalline resin in a second temperature rising process from 0° C. to 200° C.

2. The toner described in claim 1, wherein the toner has a glass transition point of 25 to 50° C.

3. The toner described in claim 1, wherein the crystalline resin is a crystalline polyester resin.

4. The toner described in claim 1, wherein the crystalline resin has a melting point of 40 to 95° C.

5. The toner described in claim 1, wherein the crystalline resin is crystalline resin particles with a particle size of 40 to 280 nm as a volume-based median size.

6. The toner described in claim 5, wherein the binder resin is binder resin particles having a core/shell structure in which each particle of the crystalline resin particles is covered with a shell composed of the amorphous resin.

7. The toner described in claim 6, wherein the binder resin particles having the core/shell structure and colorant particles are made to form colored particles, and each of the colored particles is further covered with an amorphous resin so as to form a core/shell structure.

8. A production method of producing toner for developing electrostatic latent images, comprising:
an aggregating and heat-fusion bonding process of mixing a water-based dispersion liquid of binder resin fine particles and a water-based dispersion liquid of colorant fine particles and making the binder resin fine particles and colorant fine particles to cause aggregating and heat-fusion bonding so as to form colored particles;
wherein each of the binder resin fine particles includes an amorphous resin obtained from a radical polymerizable monomer unit containing a styrene type monomer and a (meth)acrylic ester type monomer and a crystalline resin, and a ratio (Q2/Q1) is 0.85 or more, where Q1 represents an amount of absorbed heat based on an endothermic peak derived from the crystalline resin in a first temperature rising process from 0° C. to 200° C. in measurement with a differential scanning calorimeter, and Q2 represents an amount of absorbed heat based on an endothermic peak derived from the crystalline resin in a second temperature rising process from 0° C. to 200° C.

9. The production method described in claim 8, wherein the binder resin particles have a core/shell structure in which a core particle composed of the crystalline resin is covered with a shell composed of the amorphous resin.

10. The production method described in claim 9, wherein the core/shell structure is structured in such a way that seed polymerization of a radical polymerizable monomer unit containing a styrene type monomer and a (meth)acrylic ester type monomer is caused in a water-based dispersion liquid of crystalline resin fine particles so as to form a shell of the amorphous resin on a core particle of the crystalline resin.

11. The production method described in claim 8, wherein the amorphous resin has a glass transition point of 25 to 50° C., and the binder resin has a melting point of 40 to 95° C.

12. The production method described in claim 8, wherein surfaces of the colored particles obtained in the aggregating and heat-fusion bonding process is covered with an amorphous resin so as to form a core/shell structure.
